(19) United States
(12) Patent Application Publication
(10) Pub. No.: US 2009/0310213 A1
(43) Pub. Date: Dec. 17, 2009

(54) Microscope

(76) Inventors: Paul Hing, Owingen-Billafingen (DE); Martin Vogel, Weinheim (DE); Stefan Bickert, Uberlingen (DE)

Correspondence Address: POSZ LAW GROUP, PLC, 12040 SOUTH LAKES DRIVE, SUITE 101, RESTON, VA, 20191, US

(21) Appl. No.: 11/922,088

(22) PCT Filed: Jun. 13, 2006
(86) PCT No.: PCT/EP2006/005665

§ 371 Date: Dec. 12, 2007

(30) Foreign Application Priority Data
Jun. 13, 2005 (DE) 10 2005 027 312.2

(51) Int. Cl. G02B 21/06; G02B 21/36

(52) U.S. Cl. 359/363; 359/390; 359/387; 359/385

(57) ABSTRACT

The invention is based on a microscope (2), in particular a fluorescence analysis microscope, comprising an illumination carrier (20) and illumination units (22a, 22b) arranged thereon for a reflected-light illumination of a sample region (10).

In order to be able to illuminate a sample region (10) uniformly in a simple manner by means of a compact device, it is proposed that at least three illumination units (22a, 22b) for the simultaneous reflected-light illumination of the sample region (10) from different directions are arranged on the illumination carrier (20).

### PRIOR ART

The invention is based in particular on a microscope according to the preamble of claim 1.

DE 29 44 214 discloses a fluorescence analysis microscope in which a sample is illuminated from different directions by means of a plurality of illumination sources. In this case, the illumination sources emit radiation in respectively different wavelength ranges.

It is an object of the present invention, in particular, to specify a microscope in which a sample can be illuminated as uniformly as possible. This object is achieved according to the invention by means of the features of claim 1. Further configurations emerge from the subclaims.

### ADVANTAGES OF THE INVENTION

The invention is based on a microscope, in particular a fluorescence analysis microscope, comprising an illumination carrier and illumination units arranged thereon for the reflected-light illumination of a sample region. It is proposed that at least three illumination units for the simultaneous reflected-light illumination of the sample region from different directions are arranged on the illumination carrier. As a result of this, the sample region can be illuminated uniformly, whereby—particularly during the fluorescence analysis—a high and uniform emission can be obtained without any shading regions of the sample region. It is possible to detect samples having a large area, such as preferably having an area with a diameter of greater than 3 mm, in an image, and it is additionally possible to achieve a high resolution, preferably a resolution of greater than 8 Mpixels.

In order to increase the symmetry, the illumination units are expediently shaped identically. The illumination units comprise in each case at least one illumination source. These illumination sources are expediently embodied identically in terms of type and emission characteristic, whereby a uniform illumination of the sample region can be achieved in a simple manner. The illumination sources can advantageously be driven separately by a control unit, such that the uniform illumination can be achieved particularly simply and reliably, for example by means of a calibration. The illumination units expediently emit radiation onto the sample region in each case at an identical angle, whereby a particularly homogeneous illumination can be achieved.

A further advantage is achieved if illumination units with illumination sources which emit radiation with different wavelength ranges are arranged on the illumination carrier, whereby a plurality of tests or analyses can be carried out simultaneously and/or sequentially in succession, for example with two or more dyes. Furthermore, advantageous overall evaluations can be made possible.

Furthermore, the microscope preferably has a multi-bandpass emission filter having a plurality of passbands, whereby an advantageous detection of emissions of a plurality of dyes can be achieved and it is possible to avoid changing a filter when carrying out different analyses. Moveable parts and resultant error sources and costs can be avoided. It is possible to increase the throughput or the number per unit time, whereby together with the saving of reagents a considerable cost saving is made possible.

In a further configuration of the invention it is proposed that the illumination units are shaped identically and are arranged on a plurality of receptacle regions of the illumination carrier which are provided for them. As a result of this, it is possible to achieve a modular construction of the microscope, in which case illumination units can be exchanged in a simple manner and the illumination of the sample region can be adapted to desired measurements in a particularly simple and cost-effective manner. The illumination units are advantageously attached to the illumination carrier and can additionally be screwed thereto.

The uniformity of the illumination of the sample region can be increased further if at least four illumination units are arranged on the illumination carrier, the illumination beam paths of said illumination units being arranged in ring-shaped fashion with respect to the sample region. It is additionally possible to achieve a compact arrangement of the microscope as a result of this. Given a high number of illumination units on the illumination carrier, the illumination carrier can have a cooling element, such as a cooling fin for example. In this case, the cooling element has a shaping that is provided for cooling purposes and is especially suitable for cooling purposes.

A precise orientation of illumination beam paths with respect to a detection beam path can be achieved in a simple manner if the illumination carrier forms a channel for a detection beam path from the sample region to a camera. A detection optic can be inserted, for example plugged, into said channel, in which case a complicated alignment of the illumination beam paths with respect to the detection beam path can be obviated.

It is additionally proposed that the microscope comprises a detection beam path from the sample region to a camera, the illumination carrier being arranged in ring-shaped fashion around the detection beam path. As a result of this it is possible to achieve a compact arrangement of the microscope in conjunction with homogeneous illumination of the sample region. A stable, compact microscope that can be assembled in a simple manner can be achieved if the illumination carrier is embodied in one piece. The illumination carrier is expediently produced by the injection-molding method. Equally advantageously, the illumination carrier expediently carries all the illumination units of the microscope.

The compactness of the microscope can be increased further if the illumination units are arranged in two cone arrangements on the illumination carrier. A very homogeneous illumination of the sample region can be obtained by means of the conical forms. A top side and underside of the illumination carrier can be utilized for the compact arrangement of illumination units if a cone vertex of one of the cone arrangements is located above, and one below, the illumination carrier.

The compactness of the microscope can be increased further if at least two illumination units form a double unit, the illumination beam paths of which are combined by a coupling-mirror.

A particularly precise decoupling of the illumination of the sample region from the emission from the sample region can be achieved if the microscope comprises a detection beam path extending from the sample region to a camera and an illumination beam path extending from an illumination unit to the sample region, the detection beam path and the illumination beam path being guided completely separately from one another.

An exact and low-loss orientation of radiation from the illumination units, particularly when using illumination sources of different emission wavelengths, can be achieved if the reflected-light illumination is effected in each case along an illumination beam path from an illumination unit to the sample region and the illumination beam paths are guided completely separately from one another.

Illumination units of small construction with emission characteristics that are particularly suitable for fluorescence analysis can be achieved if the illumination units in each case comprise an illumination source with at least one LED.

Furthermore, a microscope comprising a camera and comprising a computing unit is proposed, wherein the computing unit is provided for monitoring a process by means of the camera, that is to say is provided in particular for detecting image data during a process proceeding within a sample, such as in particular before and/or during a marking process of a sample by means of dyes. In this case, a computing unit should be understood to mean in particular a control and/or regulating unit which has one or more processors and in particular one or more memory units with a specific operating software stored therein. Furthermore, “provided” should be understood to mean specifically equipped, designed and/or programmed.

By means of a corresponding configuration, additional useful information items can be obtained and the measurement result can be improved, to be precise in particular if the computing unit is provided for at least partly eliminating disturbing effects identified during the process, such as in particular by means of a software-aided correction method in order to reduce signal noise. A corresponding correction algorithm is preferably stored in a memory unit of the computing unit.

It is furthermore proposed that the microscope has a computing unit provided for carrying out a calibration on the basis of a reference object, whereby the measurement result can be improved in a simple manner. In this case, the reference object can be arranged at different regions that appear to be practical to the person skilled in the art, such as, in particular, in the region of a sample carrier and/or on a sample itself, and/or it can also be formed by a known sample itself.

If the microscope has a computing unit provided for evaluating detected image data, quantities of data that are to be processed by an operator can be reduced, to be precise in particular if it is possible to output results in numerical values and/or characteristic quantities which can be used for unambiguously identifying whether a test is positive or negative.

In a further configuration of the invention it is proposed that the microscope has an at least partly automated adjusting unit for adjusting a position of a sample relative to an optical sensor, such as, in particular, a mechanical and/or optical adjusting unit, such as, for example, an autofocus unit. By means of a mechanical adjusting unit, in this case the sample can be moved relative to the optical sensor, and/or the optical sensor can be moved relative to the sample manually and/or advantageously in an at least partly automated manner. Preferably, the at least partly automated adjustment takes place in real time, in which case “real time” should be understood to mean adjustment directly before and/or during detection of measurement data.

If the microscope has an at least substantially telecentric emission optic, on the object side and/or on the image side, it is possible to avoid undesirable changes, in particular during focusing and it is possible to achieve a uniform angle of light incidence over an entire field of view of an image sensor, whereby an advantageous homogeneous sensitivity can be obtained. Furthermore, it is possible to use microlenses whose performance is dependent on the angle of incidence. In this case “substantially” should be understood to mean in particular that optics having tolerance-dictated deviations from 100% telecentricity are intended to fall within the scope of protection.

It is furthermore proposed that the microscope has at least one passive optical means for homogenizing an illumination intensity. In this case, a “passive optical means”, in contrast to an illumination source, should be understood to mean in particular a lens, a mirror, etc., use preferably being made of optical means having specific surface contours which are provided for example for at least partly compensating for intensity differences caused by an oblique angle of incidence. Furthermore, optical means with holographically produced microstructures are particularly advantageously used, whereby it is possible to achieve an advantageous homogeneity with at the same time high transmission.

It is possible to achieve a microscope at least largely without moveable parts, in particular relative to an illumination module, which can be embodied in small, lightweight and robust fashion, whereby it is preferably suitable for portable applications, or which can scan an area of arbitrary size or complexity by movement.

A microscope comprising an optical scattering unit is furthermore proposed, which scattering unit has optical means, in particular optical scattering means, wherein the scattering unit has at least one optical means which is provided at least for reducing a beam expansion of the scattering unit, in particular relative to a scattering unit with exclusively spherical microlenses and/or holographically produced optical means, whereby an advantageous uniform illumination can be achieved and losses can be avoided. A “scattering unit” should be understood to mean in particular a mounting unit, such as a screen, in particular, which is provided for scattering the light.

Advantageous effects can be obtained if the optical means has an axis running through an optical axis of the scattering unit, and in particular if the optical means is formed in substantially cylindrical, cylinder-segment-shaped, conical and/or cone-segment-shaped fashion, whereby—relative to an axis extending radially outward proceeding from the optical axis—it is possible to obtain an advantageous orthogonal scattering tangential to a round scattering unit. With optical means formed in conical and/or cone-segment-shaped fashion, it is possible to obtain an advantageous arrangement of the optical means alongside one another at least largely without any interspace.

If different optical means are arranged in a radial direction proceeding from an optical axis of the scattering unit, it is possible to obtain different advantageous scattering effects in a targeted manner in different regions. In particular, specific optical means which are provided at least for reducing a beam expansion are advantageously arranged in an outer edge region of the scattering unit.

The invention additionally relates to a method for calibrating a microscope. The uniform and shadow-free illumination of a sample region in an as far as possible precisely predetermined intensity is of great importance particularly during fluorescence analysis. The calibration of the microscope is expedient for this purpose. The object of this part of the invention is to specify a method for calibrating a microscope by means of which it is possible to achieve a uniform illumination of a sample region with predetermined intensity in a simple manner. This object is achieved according to the invention by means of a method for calibrating a microscope, in particular a fluorescence analysis microscope, with a plurality of illumination units which illuminate a sample region from different directions, in which a known sample is illuminated, the image thereof is evaluated by an image processing, an undesirably illuminated partial region of the sample region is determined and at least one illumination parameter of one of the illumination units is altered by means of a stipulation obtained from the determination. It is possible to achieve a uniform illumination of a sample region with predetermined intensity in a simple manner. The illumination parameter can be emission intensity of an illumination source of one of the illumination units.

The microscope according to the invention can be used in various analyses which appear to be practical to the person skilled in the art, but particularly advantageously in cell-based analyses, in immunofluorescence analyses, in genetic analyses, such as, for example, in a so-called ELISA analysis (enzyme-linked immunosorbent assay), in a PCR analysis (prepolymerase chain reaction), in a real-time PCR analysis, etc., and/or in particular in order to determine the number of elements of a sample, such as preferably blood cells in an HIV test. Furthermore, the microscope is very well suited to at least partly automated biological and/or chemical methods, such as, in particular, methods with “biochips” or “lab-on-chip”, relatively complex biochemical processes being carried out automatically under the microscope.

Furthermore, a method with a microscope is proposed in which before a measurement in the case of a sample an illumination unit is activated, the spectral properties of which lie at least substantially outside an absorbance range of at least one dye used in the case of the sample, whereby a phasing of dyes can be at least largely avoided. “Lying substantially outside an absorbance range” should be understood to mean, in particular, that the band ranges relative to the absorbance range of the dye overlap by less than 10%, preferably by less than 5%, and particularly advantageously do not overlap. In order to use the illumination for an autofocus process, an illumination unit whose spectrum overlaps one or more wavelength passbands of an emission filter is advantageously used.

If at least one unit of the microscope is moved over a sample during a measurement, relatively large regions can be detected or scanned in a simple manner, and disturbing effects caused by a movement of the sample can be avoided. If a movement of the sample under the microscope can be avoided, connections such as preferably electrical contacts, connections for reagents and/or fluids, etc. can advantageously be provided on a sample carrier or object carrier, to be precise in particular in order to supply a sample with power, reagents and/or fluids.

It is furthermore proposed that a part of the imaging and/or of the measurement field is used for detecting “sample information items”, preferably simultaneously with the detection of the samples. “Sample information items” should be understood to mean markings such as bar codes, for example, which contain items of information about the samples, and/or markings which serve for alignment or spatial determinations, and/or reference samples which serve for calibration, in particular intensity and/or spectral.

### DRAWING

Further advantages will become apparent from the following description of the drawing. The drawing illustrates an exemplary embodiment of the invention. The drawing, the description and the claims contain numerous features in combination. The person skilled in the art will expediently also consider the features individually and combine them to form practical further combinations.

In the figures:

FIG. 1 shows a microscope for fluorescence analysis,

FIG. 2 shows an illumination carrier of the microscope in a perspective view with two illumination units illustrated in an exploded view,

FIG. 3 shows the illumination carrier from FIG. 2 in a sectional illustration with inserted illumination units,

FIG. 4 shows the illumination carrier from FIGS. 2 and 3 in a side view,

FIG. 5 shows a sample region covered by irradiation regions in a schematic illustration,

FIG. 6 shows a schematically illustrated method sequence,

FIG. 7 shows a scattering unit by itself, and

FIG. 8 shows an alternative scattering unit by itself.

### DESCRIPTION OF THE EXEMPLARY EMBODIMENT

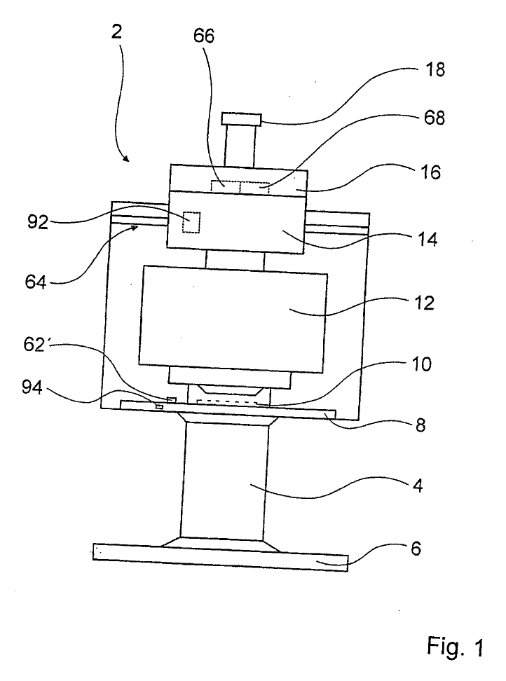

FIG. 1 shows, in a schematic illustration, a microscope 2 for fluorescence analysis or a fluorescence analysis microscope comprising a stand 4, a stand base 6, for example for mounting onto a table, and an object carrier 8, in the central position of which a sample region 10 is represented for illustration purposes. The object carrier 8 has connections 94 formed by electrical contacts and by fluid connections, in particular for supplying samples. Positioned above the sample region 10 is an illumination module 12 for illuminating the sample region 10, and above that a camera 14 and a control unit 16, which controls methods that can be carried out automatically by the microscope 2 and comprises an image processing for analyzing recorded images of the sample region 10. The control unit 16 is provided for evaluating detected image data so as subsequently to be able to output final results by means of a schematically illustrated output unit 92. The control unit 16, which is formed by a computing unit and is integrated in the camera 14, has a processor unit 66 and a memory unit 68 with an operating software stored therein. Arranged above the control unit 16 is an eyepiece 18 in order to permit an operator to look directly at the sample region 10.

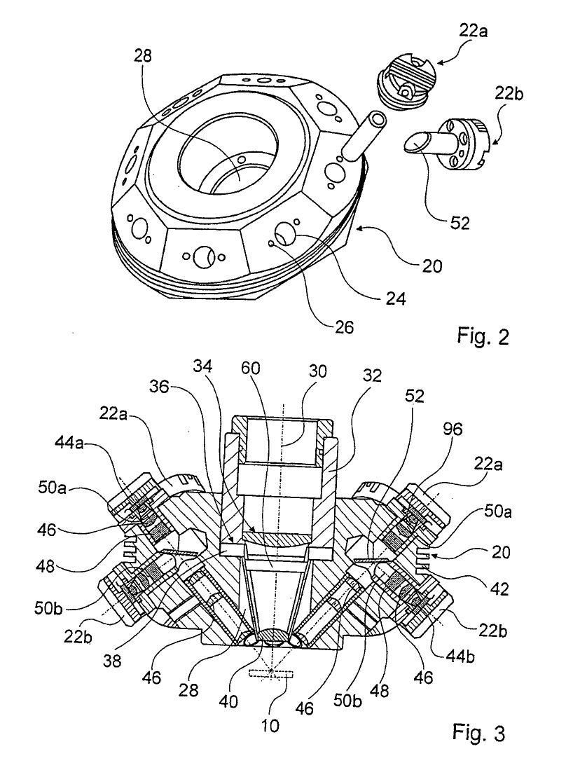

The illumination module 12 comprises an illumination carrier 20—which is illustrated in a perspective view in FIG. 2—for accommodating 16 illumination units 22a, 22b, only two of which are shown in FIG. 2. The illumination units 22a, 22b are in each case arranged at accommodating regions 24 prepared for them and are held by two screws in screw holes 26 in each case at the accommodating region 24. A channel 28 for a detection beam path 30 (see FIG. 3) is led from the sample region 10 to the camera 14 centrally through the illumination carrier 20.

The illumination carrier 20 and the illumination units 22a, 22b arranged thereon are illustrated in sectional view in FIG. 3. A camera holder 32 with a telecentric emission optic 34 illustrated schematically is inserted into the channel 28, the camera 14 (not illustrated in FIG. 2) being plugged into said camera holder. In its interior, the camera holder 32 comprises a schematically illustrated adjusting unit formed by an autofocus unit 36 with a motor 38, by means of which unit a lens 40 can be moved parallel to the detection beam path 30 upward or downward for focusing onto the sample region 10 or a sample arranged therein and it is possible to achieve an adjustment of a position of the sample relative to an optical sensor of the camera 14. The autofocus unit 36 is controlled by the control unit 16. The illumination carrier 20 is made of plastic and produced in one piece with the aid of an injection-molding method. It carries all the illumination units 22a, 22b arranged in ring-shaped or conical fashion around the detection beam path 30. In addition, the microscope has a schematically illustrated automated mechanical adjusting unit 64 with guide rails and actuator units (not specifically illustrated) for adjusting a position of the sample relative to the optical sensor of the camera 14. By means of the adjusting unit 64, the camera 14 and the illumination module 12 can be moved relative to the sample in an automated manner, to be precise parallel and transversely with respect to the detection beam path 30. The adjustment by means of the autofocus unit 36 and the mechanical adjusting unit 64 is effected during operation in real time, that is to say directly before and/or during detection of measurement data. By means of the mechanical adjusting unit 64, the camera 14 and the illumination units 22a, 22b can be moved over the sample, under the control of the control unit 16, for the purpose of scanning the sample.

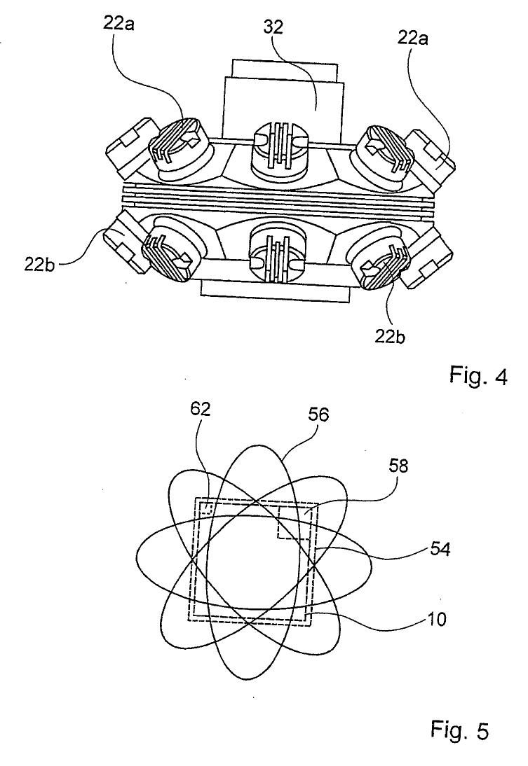

The in each case eight illumination units 22a, 22b are led—as is illustrated in FIG. 4—around the detection beam path 30 in two cone arrangements, the detection beam path 30 lying in the cone axis of the cone arrangements. In this case, the imaginary cone vertex of one of the cone arrangements is located above, and the imaginary cone vertex of the other cone arrangement below, the illumination carrier 20. The cone surfaces of the two cone arrangements are embodied at right angles to one another. Between the cone arrangements there are cooling fins 42 for cooling the illumination carrier 20, which dissipate the heat generated by illumination sources 44a, 44b, lenses 46 and spectral filters 48 to the surroundings of the illumination carrier 20. The lenses 46 form passive optical means for homogenizing an illumination intensity, to be precise in that they have surface contours and/or holographically produced microstructures which are specifically adapted to an angle of incidence of the illumination beam path.

An illumination beam path 50a, 50b respectively leads from the illumination sources 44a, 44b to the sample region 10. The illumination beam paths 50a, 50b are combined in a coupling-in mirror 52 toward the sample region 10. In this case, a respective illumination unit 22a with an illumination unit 22b arranged opposite in the direction of the detection beam path 30 forms a double unit, the beam paths 50a and 50b, respectively, of which are combined by the coupling-in mirror 52. In the coupling-in mirror 52, the illumination beam paths 50a, 50b impinge on one another at right angles.

The illumination beam paths 50a, 50b—after they have been combined in the coupling-in mirror 52—are arranged in ring-shaped fashion and at the same angle with respect to the sample region 10. They are guided from the illumination sources 44a, 44b as far as the sample region 10 completely separately with respect to the detection beam path 30. Moreover, the illumination beam paths 50a of all the illumination units 22a are guided from the illumination sources 44a as far as the sample region 10 completely separately from one another.

The illumination sources 44a, 44b are light-emitting diodes (LEDs), each illumination unit 22a, 22b having one LED in each case. In order to improve the below-described method for uniformly illuminating the sample region 10, it is possible to arrange in each illumination unit 22a, 22b in each case a plurality of LEDs, in particular in a plane perpendicular to the illumination beam paths 50a, 50b. As an alternative and/or in addition to conventional LEDs, it is possible to use laser diodes and/or solid-state lasers.

The illumination units 22a, 22b embodied identically in terms of their geometry are plugged into the illumination carrier 20 and screwed there. The illumination sources 44a are embodied differently at least in part and emit radiation in different wavelength ranges during operation. Furthermore, the illumination sources 44b are embodied differently at least in part and emit radiation in different wavelength ranges during operation. In principle, the illumination sources 44a of the illumination units 22a could be embodied identically and emit radiation in the same wavelength range. The same applies to the illumination sources 44b of the illumination units 22b.

Furthermore, the illumination sources 44b are expediently embodied differently than the illumination sources 44a at least in part in terms of their spectral range, in order to minimize the coupling-in losses as a result of the coupling of the illumination beam paths 50b into the illumination beam paths 50a with the aid of the coupling-in mirror 52. The illumination sources 44a, 44b can be divided into more than two spectral ranges in order to be able to carry out a plurality of fluorescence analyses simultaneously and/or else sequentially. In this case, in particular at least four colors or different spectral ranges are advantageous in order to be able to carry out a plurality of analyses simultaneously and in addition to have enough illumination sources 44a, 44b available per color so as to be able to uniformly illuminate the sample region 10 by the method described below. For this purpose, the illumination sources 44a, 44b can be driven separately by the control unit 16. In terms of their spectral range, the spectral filters 48 are coordinated with the illumination sources 44a, 44b. The coupling-in mirror 52 is embodied such that it is transmissive for radiation of the spectral range of the illumination sources 44a and reflective for radiation of the spectral range of the illumination source 44b. In addition, a multi-bandpass emission filter 60 coordinated with the radiation sources is arranged in the channel 28.

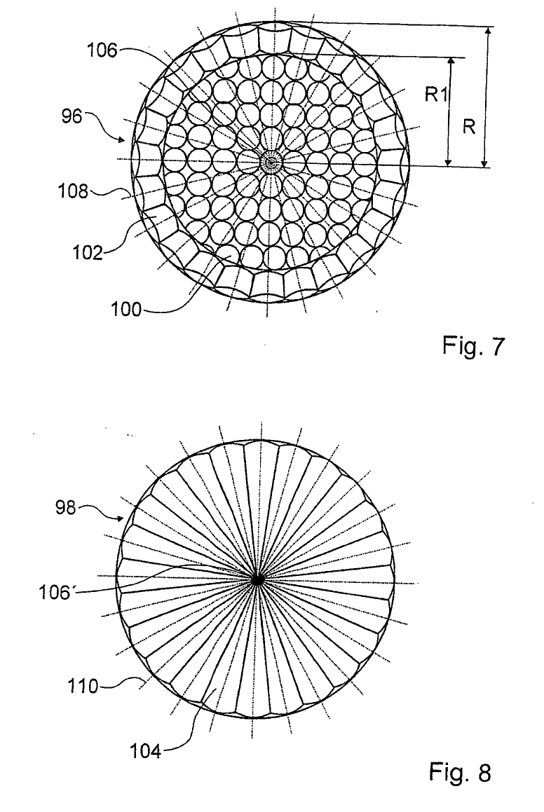

Furthermore, the microscope 2 has scattering units 96 with optical means 100, 102 arranged downstream of the illumination sources 44a, 44b in the light beam direction. The optical means 100 are formed by spherical microlenses or by holographically created optical means, while the optical means 102 are formed by semicylindrical microlenses which have a cylindrical axis 108 running through an optical axis 106 of the scattering unit and are provided for avoiding beam expansion by the scattering unit 96 (FIG. 7). Different optical means 100, 102 are arranged in the radial direction proceeding from the optical axis 106 of the scattering unit 96, to be precise the optical means 100 are arranged within a radius R1 and the optical means 102 are arranged outside the radius R1 or in an outer edge region between the radius R1 and a radius of the scattering unit 96.

FIG. 8 illustrates an alternative scattering unit 98 with conical optical means 104, the cone or central axis 110 of which runs through an optical axis 106′ of the scattering unit 98 and extends as far as the edge of the scattering unit 98 proceeding from the optical axis 106′. The optical means 104 are provided, in a manner corresponding to the optical means 102, for at least reducing or avoiding beam expansion caused by the scattering unit 98.

For the calibration of the microscope 2, a known standard sample 54 (see FIG. 5) is introduced into the sample region 10. Said standard sample 54 contains structures which are identified by the image processing of the control unit 16, whereby in an autofocus method the autofocus unit 36 is driven, the lens 40 is optimally positioned and the standard sample 54 is focused. Afterward, the standard sample 54 or the sample region 10 is illuminated by some or all of the illumination units 22a, 22b.

By way of example, all the illumination sources 44a emit radiation in one spectral range or with one color, and all the illumination sources 44b emit radiation in another spectral range. In this case, for example firstly the standard sample 54 is illuminated by means of the illumination sources 44a. Each double unit comprising a respective illumination unit 22a, 22b then illuminates the sample region 10 with an illumination field 56, such that the sample region 10 is illuminated with eight overlapping illumination fields 56. The standard sample 54 is examined by the image processing of the control unit 16 with regard to its brightness, it being ascertained, for example, that a partial region 58 of the sample region 10 is illuminated only inadequately. Those illumination fields 56 which at least partly cover the partial region 58 are then illuminated more brightly relative to the other illumination fields 56 in a manner such that the partial region 58 is illuminated in a desired manner in relation to the entire sample region 10, such that the entire sample region 10 is now illuminated uniformly as desired. Afterward, the standard sample 54 is illuminated by means of all the illumination sources 44b, which generate the same illumination fields 56 as the illumination sources 44a, and the method is carried out analogously for said illumination sources 44b. However, the calibration method can also be carried out simultaneously for a plurality of spectral ranges used.

With the use of a plurality of LEDs per illumination unit 22a, 22b, each illumination field 56 can be varied in terms of its brightness not only altogether but also regionally, whereby the entire sample region 10 can be illuminated particularly uniformly with the aid of the calibration method.

With the calibration of the illumination of the sample region 10 thus achieved, quantitative evaluations can be carried out in a particularly reliably reproducible and simple manner with the microscope 2.

The control unit 16 is provided for monitoring a process by means of the camera, to be precise for detecting image data before and during a marking process by means of dyes and for eliminating disturbing effects identified during and/or after the monitoring at least partly by means of an algorithm. Furthermore, the control unit is provided for carrying out a calibration on the basis of a reference object 62 arranged on a sample—as is indicated in FIG. 5—and/or on the basis of a reference object 62′ separated from a sample on the object carrier 8.

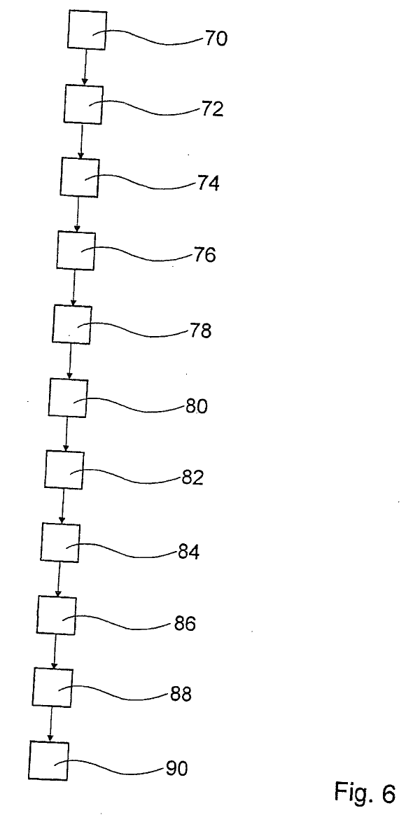

A schematically illustrated method sequence is illustrated by way of example in FIG. 6. In a method step 70, a sample is inserted into the sample region 10. In a subsequent method step 72, a calibration is carried out on the basis of a reference object 62 arranged on the sample. Afterward, in a method step 74, before a marking of the sample with dyes, image data of the sample are detected in order that subsequently, in a method step 76, disturbing effects identified are eliminated by software technology. Sample information items provided laterally alongside the sample are additionally detected in method step 74.

In a method step 78, the sample is marked with dyes. Afterward, in a method step 80, the illumination units 22a, 22b are activated, the spectral properties of the latter lying outside the absorbance ranges of the dyes used in the case of the sample, and measurement-optimizing settings are performed. In a method step 82, the sample is irradiated by means of illumination sources 44a, 44b—which are coordinated with a first dye—with a first wavelength range, image data are detected and the number of cells of the sample that are marked by the first dye is determined.

In a method step 84, the sample is irradiated by means of illumination sources 44a, 44b—which are coordinated with a second dye—with a second wavelength range, which differs from the first wavelength range, image data are detected and the number of cells of the sample that are marked by the second dye is determined.

Afterward, in a further method step 86, the sample is simultaneously irradiated by means of illumination sources 44a, 44b with the differing wavelength ranges, in order to detect the total number of marked cells. Afterward, the detected data are evaluated within the control unit 16 in a method step 88 and, in a method step 90, a final result of the analysis carried out is output by means of the output unit 92 indicated schematically. Instead of a detection of image data in method steps 82 to 86 with a stationary camera 14, the latter can be moved over the sample by means of the mechanical adjusting unit 64 during the detection of image data manually and/or else advantageously in automated fashion. In principle, however, other sequences which appear to be practical to the person skilled in the art are also conceivable.

28.11.07

Reference symbols

| | |
|---|---|
| 2 | Microscope |
| 4 | Stand |
| 6 | Stand base |
| 8 | Object carrier |
| 10 | Sample region |
| 12 | Illumination module |
| 14 | Camera |
| 16 | Control unit |
| 18 | Eyepiece |
| 20 | Illumination carrier |
| 22a | Illumination unit |
| 22b | Illumination unit |
| 24 | Accommodating region |
| 26 | Screw hole |
| 28 | Channel |
| 30 | Detection beam path |
| 32 | Camera holder |
| 34 | Emission optic |
| 36 | Autofocus unit |
| 38 | Motor |
| 40 | Lens |
| 42 | Cooling fin |
| 44a | Illumination source |
| 44b | Illumination source |
| 46 | Lens |
| 48 | Spectral filter |
| 50a | Illumination beam path |
| 50b | Illumination beam path |
| 52 | Coupling-in mirror |
| 54 | Standard sample |
| 56 | Illumination field |
| 58 | Partial region |
| 60 | Multi-bandpass emission filter |
| 62 | Reference object |
| 64 | Adjusting unit |
| 66 | Processor unit |
| 68 | Memory unit |
| 70 | Method step |
| 72 | Method step |
| 74 | Method step |
| 76 | Method step |
| 78 | Method step |
| 80 | Method step |
| 82 | Method step |
| 84 | Method step |
| 86 | Method step |
| 88 | Method step |
| 90 | Method step |
| 92 | Output unit |
| 94 | Connections |
| 96 | Scattering unit |
| 98 | Scattering unit |
| 100 | Optical means |
| 102 | Optical means |
| 104 | Optical means |
| 106 | Axis |
| 108 | Axis |
| 110 | Axis |
| R | Radius |
| R1 | Radius |

1-38. (canceled)

39. A microscope, in particular a fluorescence analysis microscope, comprising an illumination carrier and illumination units arranged thereon for a reflected-light illumination of a sample region, wherein at least three illumination units for the simultaneous reflected-light illumination of the sample region from different directions are arranged on the illumination carrier.

40. The microscope as claimed in claim 39, wherein the illumination units are shaped identically and are arranged on a plurality of receptacle regions of the illumination carrier which are provided for them.

41. The microscope as claimed in claim 39, wherein at least four illumination units are arranged on the illumination carrier, the illumination beam paths of said illumination units being arranged in ring-shaped fashion with respect to the sample region.

42. The microscope as claimed in claim 39, wherein the illumination carrier forms a channel for a detection beam path from the sample region to a camera.

43. The microscope as claimed in claim 39, featuring a detection beam path from the sample region to a camera, the illumination carrier being arranged in ring-shaped fashion around the detection beam path.

44. The microscope as claimed in claim 43, wherein the illumination units are arranged in two cone arrangements on the illumination carrier.

45. The microscope as claimed in claim 39, wherein at least two illumination units form a double unit, the illumination beam paths of which are combined by a coupling-in mirror.

46. The microscope as claimed in claim 39, featuring a detection beam path extending from the sample region to a camera and an illumination beam path extending from an illumination unit to the sample region, the detection beam path and the illumination beam path being guided completely separately from one another.

47. The microscope as claimed in claim 39, wherein the reflected-light illumination is effected in each case along an illumination beam path from an illumination unit to the sample region and the illumination beam paths are guided completely separately from one another.

48. The microscope as claimed in claim 39, wherein the illumination units in each case comprise an illumination source with at least one LED.

49. A microscope comprising a camera and comprising a computing unit, in particular as claimed in claim 39, wherein the computing unit is provided for monitoring a process by means of the camera.

50. The microscope as claimed in claim 39, wherein at least two illumination units have illumination sources which emit radiation with different wavelength ranges during operation.

51. The microscope as claimed in claim 39, featuring a multi-bandpass emission filter.

52. The microscope at least as claimed in claim 49, wherein the computing unit is provided for at least partly eliminating disturbing effects identified during the process.

53. The microscope as claimed in claim 39, featuring a computing unit provided for carrying out a calibration on the basis of a reference object.

54. The microscope as claimed in claim 39, featuring a computing unit provided for evaluating detected image data.

55. The microscope as claimed in claim 39, featuring an at least partly automated adjusting unit for adjusting a position of a sample relative to an optical sensor.

56. The microscope as claimed in claim 39, featuring an at least substantially telecentric emission optic.

57. The microscope as claimed in claim 39, featuring at least one passive optical means for homogenizing an illumination intensity.

58. The microscope as claimed in claim 39, featuring an object carrier with connections.

59. A microscope comprising an optical scattering unit, which comprises optical means, in particular as claimed in one of the preceding claims, wherein the scattering unit has at least one optical means which is provided at least for reducing a beam expansion of the scattering unit.

60. The microscope as claimed in claim 59, wherein the optical means has an axis running through an optical axis of the scattering unit.

61. The microscope as claimed in claim 59, wherein the optical means is formed in substantially cylindrical, cylinder-segment-shaped, conical and/or cone-segment-shaped fashion.

62. The microscope as claimed in claim 59, wherein different optical means are arranged in a radial direction proceeding from an optical axis of the scattering unit.

63. A method for calibrating a microscope, in particular a fluorescence analysis microscope, with a plurality of illumination units which illuminate a sample region from different directions, in which a known sample is illuminated, the image thereof is evaluated by an image processing, an undesirably illuminated partial region of the sample region is determined and at least one illumination parameter of one of the illumination units is altered by means of a stipulation obtained from the determination.

64. A method with a microscope as claimed in the preamble of claim 39, wherein a sample is irradiated during a process sequentially and/or simultaneously by means of at least two illumination sources with different wavelength ranges.

65. A method with a microscope as claimed in the preamble of claim 39, wherein before a measurement in the case of a sample an illumination unit is activated, the spectral properties of which lie at least substantially outside an absorbance range of at least one dye used in the case of the sample.

66. A method with a microscope as claimed in claim 49, wherein a process of a sample is monitored by means of the camera.

67. The method as claimed in the preamble of claim 66, wherein image data are detected by means of the camera before and/or during a marking process by means of dyes.

68. The method as claimed in claim 63, wherein disturbing effects identified during and/or after the monitoring are at least partly eliminated.

69. The method as claimed in claim 63, wherein a cell-based analysis is carried out.

70. The method as claimed in claim 63, wherein an immunofluorescence analysis is carried out.

71. The method as claimed in claim 63, wherein a genetic analysis is carried out.

72. The method as claimed in claim 63, wherein at least one at least partly automated biological and/or chemical method is used.

73. The method as claimed in claim 63, wherein a number of elements of a sample is determined.

74. The method as claimed in claim 63, wherein at least one unit of the microscope is moved over a sample during a measurement.

75. The method as claimed in claim 63, wherein a part of the imaging and/or of the measurement field is used for detecting sample information items.

76. The method as claimed in claim 75, wherein the sample information items are detected simultaneously with a sample.
